(19) United States
(12) Patent Application Publication
(10) Pub. No.: US 2016/0189055 A1
(43) Pub. Date: Jun. 30, 2016

(54) TUNING OF PARAMETERS FOR AUTOMATIC CLASSIFICATION

(71) Applicant: Applied Materials Israel Ltd., Rehovot (IL)

(72) Inventor: Orly ZVITIA, Tel Aviv (IL)

(21) Appl. No.: 14/588,101

(22) Filed: Dec. 31, 2014

(51) Int. Cl. G06N 99/00

(52) U.S. Cl. CPC G06N 99/005

(57) ABSTRACT

A method, system and computer software product for tuning a classification system. The tuning method receives training data including items, each associated with a training class label, and obtains test data including association of each item with an automatic class label and corresponding values of a first confidence level and a second confidence level. Per automatic class, the method generates two or more performance metrics based on the training data and the test data. The method selects, for each automatic class, a preferred pair of values of the first confidence threshold and the second confidence threshold for which, by rejecting all items bellow the first and second thresholds, with respect to all of the automatic classes, a global optimum condition of the performance metrics is met.

### FIELD OF THE DISCLOSURE

The present disclosure relates generally to automated classification and specifically to methods and systems for analysis of manufacturing defects.

### BACKGROUND

Automatic Defect Classification (ADC) techniques are widely used in inspection and measurement of defects on substrates in the semiconductor industry. These techniques are aimed at detecting the existence of defects, and classify them automatically by type, in order to provide more detailed feedback on the production process and reduce the load on human inspectors. ADC is used, for example, to distinguish among types of defects arising from particulate contaminants on the wafer surface and defects associated with irregularities in the microcircuit pattern itself, and may also identify specific types of particles and irregularities.

### SUMMARY

Embodiments of the present disclosure that are described hereinbelow provide improved methods, systems and software for automated classification.

According to an embodiment of the invention, there is provided a method for tuning a classification system. The classification system may include multi-class and single-class classifiers defining classification rules. The method may receive training data including items. Each item may be associated with a training class label. The method may obtain test data including association of each item with an automatic class label and corresponding values of a first confidence level and a second confidence level. The method may, per automatic class, generate two or more performance metrics based on the training data and the test data. The method may select, for each automatic class, a preferred pair of values of the first confidence threshold and the second confidence threshold for which, by rejecting all items bellow the first and second thresholds, with respect to all of the automatic classes, a global optimum condition of the performance metrics is met. The items may be suspected defects inspected on a semiconductor substrate.

According to an embodiment of the invention, the global optimum condition may be met under one or more performance constraints applied to the performance metrics.

According to an embodiment of the invention, the operation of selecting a preferred pair of values of the first confidence threshold and the second confidence threshold, may include, for each automatic class, generating a group of candidate pairs of values; and selecting from among the candidate pairs of values, a preferred pair of values for which, with respect to all of the automatic classes, a global optimum condition of the performance metrics is met.

The method may select the preferred pair of values based on input received from a user regarding one or more of desired performance levels. The method may plot a graph representing a set of candidate pairs of values. The method may allow the user to use the graph for selecting the preferred pair of values. The graph may be constructed by defining a grid of a first performance metric on x axis and finding a global optimum condition of a second performance metric for y axis for each point of the first performance metric.

The method may apply the one or more performance constraint to the group of candidate pairs of values to generate a group of permitted pair values. The method may select or allow the selection by a user of the preferred pair of values, from the group of permitted pair of values.

The method may obtain the test data by applying the classification rules to at least a portion of the training data, with the first threshold and the second threshold set to given values.

The method according may generate the two or more performance metrics comparing the training class label with the automatic class labels.

The method may generate the two or more performance metrics by applying the classification rules to the training data multiple times, with the first threshold and/or the second threshold set to a different value each time. The performance metrics may relate to one or more performance measures from one or more of: a purity measure, representing items which were classified as belonging to one of the automatic classes and have the same training class and test class; an accuracy measure, representing all items which are classified correctly; rejection rate of majority items, representing the number of items that the classification system should have classified as belonging to one of the automatic classes but is unable to classify with confidence; item of interest rate, representing the number of items that are identified correctly as belonging to specific automatic class; minority extraction, representing the number of items that are identified correctly as not belonging to automatic classes; false alarm rate, representing a number of items that should have been rejected and are classified as belonging to one of the automatic classes, out of the total number of rejected items.

The performance constraint may be selected from at least one of: minimal purity; minimal accuracy; maximal rejection rate of majority items; minimal item of interest rate; minimal minority extraction; maximal false alarm rate; minimal confidence threshold value.

The first confidence threshold and second confidence threshold may be selected from at least one of: ‘Unknown’ confidence threshold, representing a confidence level for which, an item that is classified by a single-class classifier as belonging to an automatic class with confidence level below the ‘Unknown’ confidence threshold will be rejected; ‘Cannot decide’ confidence threshold, representing a confidence level for which, an item that is classified by a multi-class classifier as belonging to an automatic class with confidence level below the ‘Cannot decide’ confidence threshold will be rejected; ‘Item of interest’ confidence threshold, representing a confidence level for which, an item that is classified by a multi-class and single-class classifiers as belonging to a specific automatic class with confidence level below the ‘Item of interest’ confidence threshold will be rejected.

According to an embodiment of the invention there is provided an apparatus for tuning a classification system. The apparatus may include a memory and a processor configured to: receive training data including items, each associated with a training class label; obtain test data including association of each item with an automatic class label and corresponding values of a first confidence level and a second confidence level; wherein the processor is further configured for: per automatic class, generate two or more performance metrics based on the training data and the test data; and select for each automatic class a preferred pair of values of the first confidence threshold and the second confidence threshold for which, by rejecting all items bellow these thresholds, with respect to all of the automatic classes, a global optimum condition of the performance metrics is met.

According to an embodiment of the invention there is provided an apparatus for tuning a classification system. The apparatus may include a memory and a processor operatively coupled with the memory to: receive training data including items, each associated with a training class label; obtain test data including association of each item with an automatic class label and corresponding values of a first confidence level and a second confidence level; wherein the processor is further configured for: per automatic class, generate two or more performance metrics based on the training data and the test data; and select, for each automatic class, a preferred pair of values of the first confidence threshold and the second confidence threshold for which, by rejecting all items bellow the first and second thresholds, with respect to all of the automatic classes, a global optimum condition of the performance metrics is met.

According to an embodiment of the invention there is provided a non-transitory computer-readable medium including instructions, which when executed by a processor, cause the processor to: receive training data including items, each associated with a training class label; obtain test data including association of each item with an automatic class label and corresponding values of a first confidence level and a second confidence level; per automatic class, generate two or more performance metrics based on the training data and the test data; and select for each automatic class a preferred pair of values of the first confidence threshold and the second confidence threshold for which, by rejecting all items bellow the first and second thresholds, with respect to all of the automatic classes, a global optimum condition of the performance metrics is met.

According to an aspect of the invention, there is provided a method for classifying items. During a setup stage, the method may tune a classification system, and during a classification stage, the method may receive classification data including items and may classify the items by the classification system. The method may select, during the setup stage, a preferred pair of values of a first confidence threshold and a second confidence threshold. The method may, during the classification stage, classify the classification data by applying the preferred pair of values of a first confidence threshold and a second confidence threshold.

According to an aspect of the invention, there is provided a system for classifying items. The system may include a classification module capable of receiving classification data items and classifying the items based on automatic classes, wherein the classification module comprising an apparatus for tuning.

The present invention will be more fully understood from the following detailed description of the embodiments thereof, taken together with the drawings in which:

### BRIEF DESCRIPTION OF THE DRAWINGS

FIG. 1 is an illustration of a defect inspection and classification system that includes a tuning module, in accordance with an embodiment of the present invention.

FIG. 2 is a representation of a feature space containing inspection feature values belonging to different defect classes, in accordance with an embodiment of the present invention.

FIG. 3 is a table that illustrates an example training data and test data, in accordance with an embodiment of the present invention.

FIG. 4 is an illustration of a classification method and auto-tuning method in accordance with an embodiment of the invention.

FIG. 5 is an illustration of a graph presented to a user in accordance with an embodiment of the invention.

FIG. 6 is a block diagram of an example computer system that may perform one or more of the operations described herein, in accordance with various implementations.

### DETAILED DESCRIPTION OF EMBODIMENTS

Overview

Automatic Defect Classification systems (ADC) are used in various fields, such as semiconductor manufacturing. The classification system is characterized by being able to classify the defects into a plurality of classes in accordance with classification rules. The classification rules are defined with certain confidence thresholds. The performance of a classification system is measured by performance measures, such as accuracy, purity, rejection rate and the like, and the performance measures depend on the selection of the confidence levels.

Aspects of the present disclosure relate to improving the performance of a classification system by tuning the classification system. Aspects of the present disclosure relate to improving the performance of a classification system by optimizing the determination of confidence thresholds. Aspects of the present disclosure relate to improving the performance of a classification system by improving the automation of classifier setup stage. Aspects of the present disclosure relate to tuning a classification system by defining certain performance measures as constraints and optimizing the confidence thresholds under the performance measures constraints.

The classification system is characterized by being able to classify the defects into a plurality of classes in accordance with classification rules. According to an embodiment of the disclosure, the classification system classifies a defect by determining if the defect belongs to a certain defined volume in the space (class) or not (reject), and the classification rules may further include rejection rules for identifying which of the defects cannot be classified into the plurality of classes. As a matter of illustration, each class can be viewed as a volume in the multi-dimensional space. Defects in an overlap region between the respective ranges of at least two of the defect classes can be rejected from classification.

Rejected defects can be labeled as ‘cannot decide’ (e.g., may belong to more than one class: in other words, fall in a place in the multi-dimensional space that may be part of more than one class volume). Rejected defects can be labeled as ‘unknown’ (e.g., may not belong to a known class: in other words, fall in a place in the multi-dimensional space that is not part of a class volume).

The classification system is further characterized by a certain threshold confidence level associated with the classification results. As a matter of illustration, the threshold confidence level is used for drawing the borders of a class volume in the multi-dimensional space. The borders of the class volumes depend on the threshold confidence levels and different confidence levels will yield different class volumes (class definitions). The bounds of a class volume may be larger or smaller depending on the threshold confidence level that is chosen in order to distinguish between defects that are identified as belonging to the class and those that are not.

The performance of a classification system is measured by performance measures, such as accuracy, purity, rejection rate and the like.

The performance measures depend on the selection of confidence levels.

Classification systems are trained for a desired classification performance during a setup stage. Training data is used in a setup stage. The training data corresponds to inspection data which may be pre-classified by a human operator. Based on the training data, the classification system assesses different, alternative sets of values of classification thresholds for the defined classes. Applying the classification rules to the training data using the corresponding threshold values generates test classification results that yield certain performance measures. Based on a desired performance measure, or a combination of performance measures, a specific set of confidence thresholds for the classes is determined.

Classification systems that employ rejection rules may assign a classification result with either a ‘Cannot Decide’ (CND) confidence level or an ‘Unknown’ (UNK) confidence level. This can be achieved, for example, by using single-class and multi-class classifiers. The single-class classifiers are configured for producing, for each defect, a probability of belonging to a given class. If the probability is above a certain threshold, the defect is considered to belong to the class. Otherwise, it is classified as ‘unknown’. A multi-class classifier is configured for producing, for each defect, a probability of belonging to one of a given set of class. If the probability is above a certain threshold, the defect is considered to belong to a specific one of the classes. Otherwise, it is classified as ‘cannot decide’. The setup of such a classification system requires the determination of both ‘unknown’ confidence threshold and ‘cannot decide’ threshold for each class.

Aspects of the disclosure are aimed at improving classifier performance by automating the determination of a so-called classifier ‘working point’ —the determination of preferred confidence thresholds for classes. The disclosure may optimize the determination of preferred confidence thresholds for classes with respect to two or more performance measures. While a certain confidence threshold optimizes a specific performance measure, it may deteriorate a different performance measure. In other words, the classification system may be required, depending on operational needs, to adhere with competing performance measures. Thus, in essence, defining optimal confidence thresholds for the classes is an optimization under constraint problem. The performance measures are set at desired level (constraints) and optimization under constraint algorithms are employed.

System Description

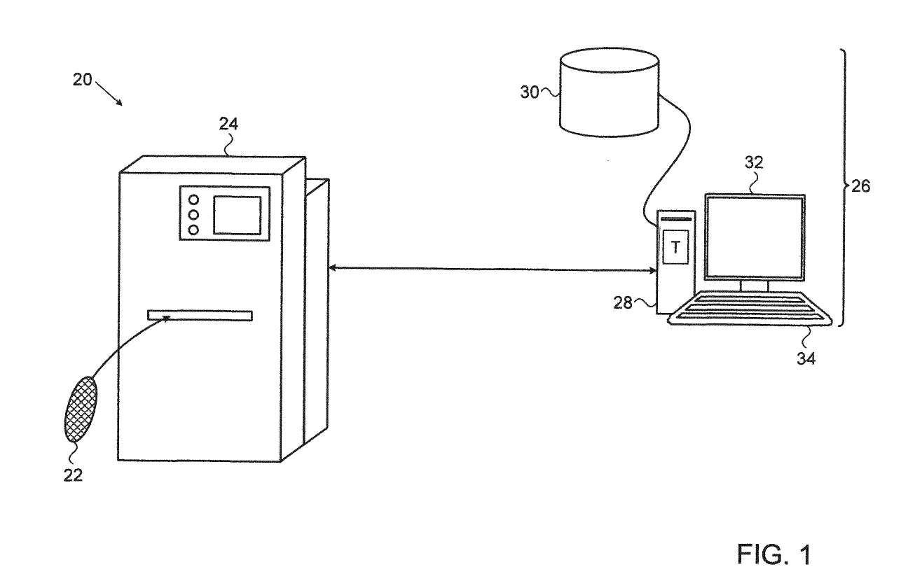

FIG. 1 is an illustration of a system 20 for automated defect inspection and classification in accordance with an embodiment of the present invention. A sample, such as a patterned semiconductor wafer 22, is inserted into an inspection machine 24. Machine 24 may inspect the surface of wafer 22, sense and process the inspection results, and output inspection data including, for example, images of defects on the wafer. Additionally or alternatively, the inspection data may comprise a list of suspected defects or defects found on the wafer, including the location of each defect, along with values of inspection features associated with each defect. The inspection features may include, for example, the size, shape, scattering intensity, directionality, and/or spectral qualities, as well as defect context and/or any other suitable features that are known in the art.

Machine 24 may comprise, for example, a scanning electron microscope (SEM) or an optical inspection device or any other suitable sort of inspection apparatus that is known in the art. Machine 24 may inspect the full surface of the wafer, portions thereof (e.g., the entire die or portions of the die) or selection locations. Machine 24 may be operable for semiconductor inspection and/or review applications, or any other suitable application. Whenever the term “inspection” or its derivatives are used in this disclosure, such an inspection is not limited with respect to specific application, resolution or size of inspection area, and may be applied, by way of example, to any inspection tools and techniques.

Although the term “inspection data” is used in the present embodiment to refer to SEM images and associated metadata, this term should be understood more broadly in the context of the present disclosure and in the claims to refer to any and all sorts of descriptive and diagnostic data that can be collected and processed to identify features of defects, regardless of the means used to collect the data, and regardless of whether the data are captured over the entire wafer or in portions, such as in the vicinity of individual suspect locations. Some embodiments of the invention are applicable to the analysis of defects or suspected defects identified by an inspection system that scans the wafer and provides a list of locations of suspected defects. Other embodiments are applicable to the analysis of defects that are re-detected by a review tool based on locations of suspected defects that were provided by an inspection tool. The invention is not limited to any particular technology by which the inspection data is generated.

An ADC machine 26 (alternatively referred to as a classification machine) receives and processes the inspection data output by inspection machine 24. If the inspection machine does not itself extract all relevant inspection feature values from the images of wafer 22, the ADC machine may perform these image processing functions. Although ADC machine 26 is shown in FIG. 1 as being connected directly to the inspection machine output, the ADC machine may, alternatively or additionally, operate on pre-acquired, stored inspection data. As another alternative, the functionality of the ADC machine may be integrated into the inspection machine. The ADC machine may, alternatively or additionally, be connected to more than one inspection machine.

ADC machine 26 may include an apparatus in the form of a general-purpose computer, comprising a processor 28 with a memory 30 for holding defect information and classification parameters, along with a user interface comprising a display 32 and input device 34. Processor 28 includes a tuning module T and is programmed in software to carry out the functions that are described herein below. The software may be downloaded to the processor in electronic form, over a network, for example, or it may, alternatively or additionally, be stored in tangible, non-transitory storage media, such as optical, magnetic, or electronic memory media (which may be comprised in memory 30, as well). The computer implementing the functions of machine 26 may be dedicated to ADC functions including tuning function, or it may perform additional computing functions, as well. Alternatively, the functions of ADC machine 26 may be distributed among multiple processors in one or a number of separate computers. As another alternative, at least some of the ADC functions described herein below may be performed by dedicated or programmable hardware logic.

ADC machine 26 runs multiple classifiers, including both single-class and multi-class classifiers, as defined above. The embodiments that follow will be described, for the sake of illustration and clarity, with reference to machine 26 and the other elements of system 20, but the principles of these embodiments may likewise be implemented, mutatis mutandis, in any sort of classification system that is called on to handle multiple classes of defects or other unknown features.

According to one of its embodiments, the invention is implemented as a computer software product, comprising a non-transitory computer-readable medium in which program instructions are stored, which instructions, when read by a computer, cause the computer to perform classification and auto-tuning in an automated manner, with or without user input, as described herein.

Tuning of Confidence Thresholds

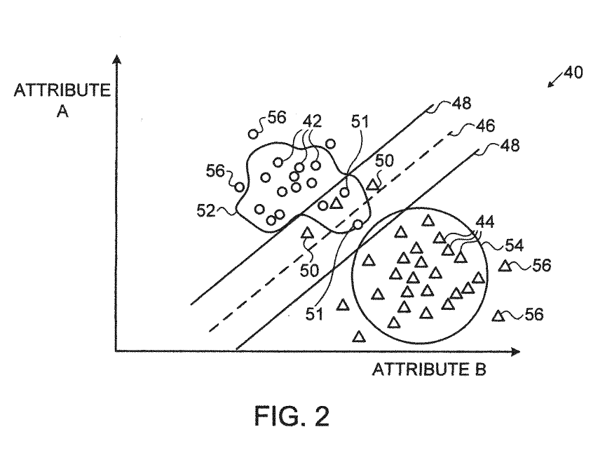

FIG. 2 is a schematic representation of a feature space 40 to which a set of defects 42, 44, 50, 51, 56 is mapped, in accordance with an embodiment of the present invention. For the sake of visual simplicity, the feature space is represented in FIG. 2 and in subsequent figures as being two-dimensional, but the classification processes that are described herein may be carried out in spaces of higher dimensionality. The defects in FIG. 2 are assumed to belong to two defined classes, one associated with defects 42 (which will be referred to below as “Class I”), and the other with defects 44 (“Class II”). Defects 42 are bounded in the feature space by a border 52, while defects 44 are bounded by a border 54. The borders may overlap.

ADC machine 26 in this example applies two types of classifiers: A multi-class classifier distinguishes between Classes I and II. The classifier in this case is a binary classifier, which defines a boundary 46 between the regions associated with the two classes. In practice, ADC machine 26 may carry out multi-class classification by superposing multiple binary classifiers, each corresponding to a different pair of classes, and may then assign each defect to the class that was most selected for this defect by the binary classifiers. After (or in parallel) defects have been classified by the multi-class classifier, single-class classifiers, represented by borders 52 and 54, identify the defects that can be reliably assigned to the respective class, while rejecting the defects outside the borders as “unknown.”

The operator of ADC machine 26 sets confidence thresholds, which determine the loci of the boundaries of the regions in feature space 40 that are associated with the defect classes. Setting the confidence threshold for multi-class classification is equivalent to placing borders 48 on either side of boundary 46. For example, the higher the confidence threshold, the farther apart will borders 48 be. The ADC machine rejects defects 51, which are located between borders 48 but within border 52, as “undecidable,” meaning that the machine cannot automatically assign these defects to one class or the other with the required level of confidence. These defects may be rejected by the ADC machine and thus are passed to a human inspector for classification. Alternatively or additionally, such defects may be passed for further analysis by any modality that adds new knowledge not available to the previous classifiers.

The confidence levels similarly control the shapes of borders 52 and 54 of the single-class classifiers. The “shape” in this context refers both to the geometrical form and the extent of the border and is associated with a parameter of a kernel function that is used in implementing the classifiers. For each value of the confidence threshold, the ADC machine chooses an optimal value of the parameter, as is described in detail in U.S. Patent Application Publication 2013/0279795. The volume defined by the borders and the geometrical shape of the borders may change as the threshold confidence level is changed.

In the example shown in FIG. 2, defects 56 fall outside borders 52 and 54 and are therefore classified as “unknown” defects. Defects 50, which are both outside borders 52, 54 and between borders 48, are also considered “unknown.” Setting a lower confidence threshold could expand border 52 and/or 54 sufficiently to contain these defects, with the result that ADC machine 26 will reject fewer defects but may have more classification errors (thus reducing the purity of classification) or lose some of the defects of interest. On the other hand, increasing the confidence threshold may enhance the purity of classification, but at the expense of a higher rejection rate or false alarm rate.

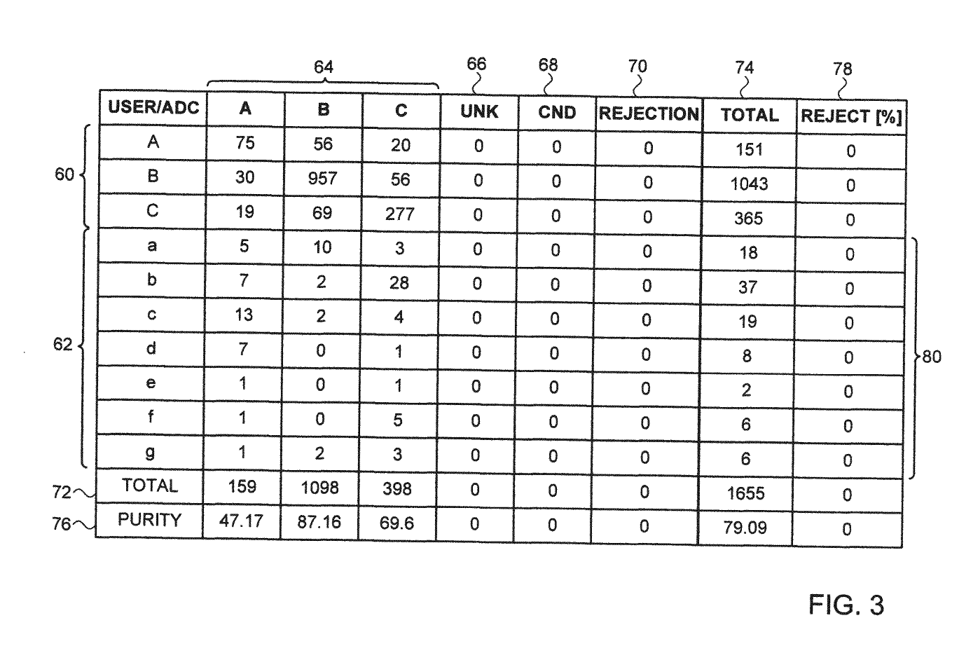

FIG. 3 is a performance metric table that illustrates training classification data and test classification data in accordance with an embodiment of the present invention. The rows in the table refer to defects in a training set that have been classified by a human inspector (“USER”) and are sorted according to the classes assigned by the inspector. Rows 60 refer to so-called “majority” defect classes A, B and C (also referred to as “automatic classes”). Majority classes are classes which, after applying the classification rules on the training data, most of the defects are identified at the training data as belonging to these classes. ADC system will be able to classify defects into the majority classes and these classes are also called “automatic classes”. Rows 62 refer to so-called “minority” defect classes a-g. Minority classes are classes which, after applying the classification rules on the training data, most of the defects which are identified at the training data as belonging to these classes will not be classified by the classification system as belonging to the automatic classes, and be rejected.

The columns of the table refer to classification of the defects by the classification system 26. Specifically, columns 64 show the classification of defects into automatic classes A, B and C by the machine. Rows 60 and 62 and columns 64 thus define a confusion matrix, in which the numbers in the cells on the diagonal correspond to correct classification by the machine, while the remaining cells contain the numbers of incorrect classifications.

FIG. 3 shows a distribution of ADC results that may occur at the start of the set up stage, prior to tuning. At this point, the confidence thresholds used in the classification are set to minimal values, without concern for the performance implications. As a result, all of the defects are classified as belonging to one of the three majority (automatic) classes. No defects have been classified by machine 26 as “unknown” (UNK) or “undecidable” (CND—“cannot decide”), and thus columns 66 and 68, containing the numbers of UNK and CND defects, are empty (e.g., showing a value of zero). The number of rejections for each class, to be listed in column 70, is similarly zero. A total row 72 gives the total number of defects classified (correctly or not) by the machine into each class or category, while a training set total column 74 indicates the actual total number of defects in the training data that were pre-classified into each of classes A-C and a-g by the human operator.

With respect to FIG. 3, a performance measure relating to purity of classification by ADC machine 26 for each of the majority classes A, B and is presented at the bottom of the respective column in a purity row 76. The purity percentage for each class is equal to the number of defects correctly classified (e.g., 75 defects in class A, 957 in class B, and 277 in class C), divided by the total number of defects assigned by the machine to the class, as listed in the entries in row 72. In this case, the purity values for classes A and C in row 76 are low—probably lower than the minimum purity level that the user of system 20 is likely to choose. At the same time, the rejection rates (expressed in percent) listed in a rejection column 78, given by the quotient of the number of rejections in column 70 divided by the total number of defects of each type in column 74, are zero.

If all of the classifiers were ideally defined, the defects were easy to classify, and the confidence thresholds were set to ideal values, then all of the minority defects in rows 62 would shift to columns 66-70, meaning that all minority defects have been rejected by ADC machine 26. At the same time the off-diagonal elements in the confusion matrix defined by columns 64 would be zero, and the number of rejections for majority classes A, B and C in column 70 would likewise be zero. In this case, the purity values for the majority classes in row 76 will be 100%, and the rejection rates for rows 60 will be 0, while identification of 80 minority defects that are shown in rows 62 will be 100%.

By the same token, for the purpose of distinguishing nuisance and false defects from DOIs (defects of interest), all DOIs should lie in the rejected columns (66 and 68) or in one or more of columns 64 that are assigned by the operator as DOI (giving a DOI capture rate of 100%). False classes should be concentrated in columns 64 that are assigned by the operator as false (giving a false alarm rate of 0%).

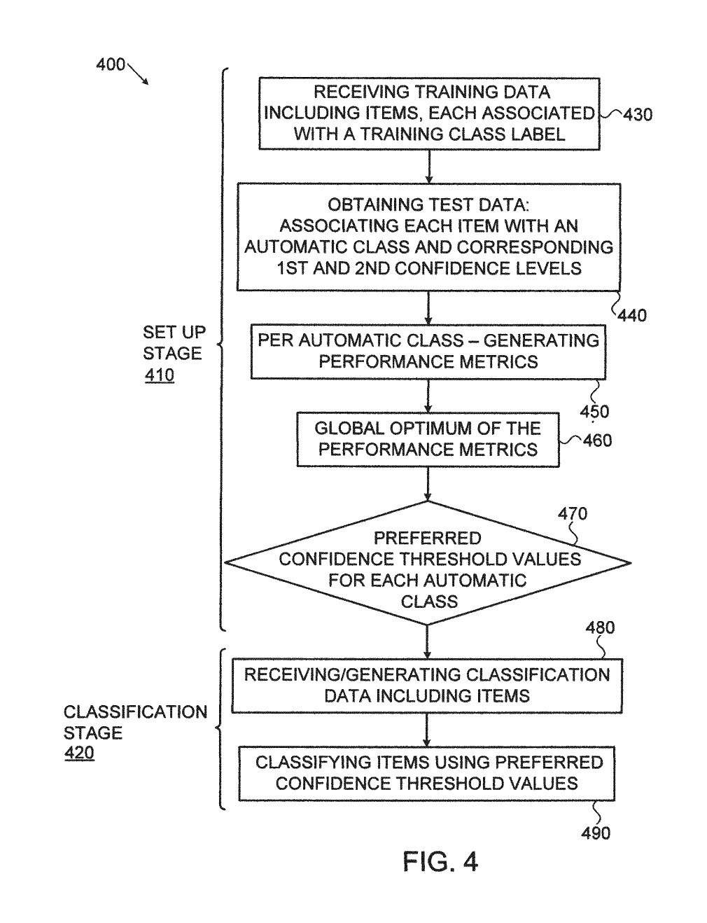

FIG. 4 is a flow chart that schematically illustrates a method for automatic defect classification, or for distinguishing between nuisance defects and Defects-of-Interest (DOIs), in accordance with an embodiment of the present invention. The method 400 comprises a sequence of operations 410 that is performed by Module T of machine 26 during a set up stage, on a training data set, to tune the ADC machine 26 by determining confidence threshold values that satisfy desired performance measures, and a sequence of operations 420 that is performed during a classification stage on inspection results for the classification of the inspection results using the confidence threshold values that were selected during the set up stage. According to an embodiment of the invention, the user is interacting with machine 26 during set up stage while during classification stage machine 26 operates substantially without user interaction. According to another embodiment of the invention, the user is interacting with machine 26 during classification stage. The method 400 may be performed by the machine 26 or the processor 28 of the machine 26 of FIG. 1.

Set up stage 410: the operations 430-470 of the set up stage will be described with reference to FIG. 4 and FIG. 3 together:

As shown, at block 430, training data may be received where the training data includes items that are each associated with a training class label. The training data may be composed with a list of items such as defects, each associated with a class label, corresponding to a given test wafer, thereby constituting the training class labels. With respect to FIG. 3, training class labels are represented in rows 60 and 62.

As shown, at Block 440, obtaining test data may be obtained, including associating each item with an automatic class label and corresponding first and second confidence levels. According to an embodiment of the invention, the test data is generated based on inspection results provided by an inspection tool (e.g., machine 24 of FIG. 1) by inspecting the test wafer for which the training data correspond. The ADC machine classifies the inspection results—in full or a sub-set thereof-to thereby associate items with classes. With respect to FIG. 3, the results of classification are represented in columns 64.

As shown, at Block 440, the performance metrics are generated per automatic (Majority) class as defined as a result of setting different confidence threshold levels. The performance metrics are generated based on the training data and test data. The performance metrics are generated by applying the classification rules to the training data multiple times with the one or more confidence thresholds set to a different value each time. Thus, the test data includes, for each automatic class, a variety of classification results, each including items associated with confidence thresholds values, giving rise to a variety of values of performance measures. Thus, a correlation between the values of the performance measures and the values of confidence thresholds is thereby received, constituting the performance metrics.

As shown, at Block 460, an optimization problem of the performance metrics is solved in order to determine preferred confidence threshold values 470 from among the group pf all confidence threshold values, for each automatic class.

Tuning of an ADC machine is achieved by optimizing the determination of preferred confidence threshold for classes with respect to two or more performance measures (e.g., purity and rejection rate). While a certain confidence threshold optimizes a specific performance measure (e.g., purity), it may deteriorate a different performance measure (e.g., rejection rate). In other words, the classification system may be required, depending on operational needs, to adhere with competing performance measures.

According to an embodiment of the invention, one or more of the performance measures may be represented as a constraint, and operation 460 is performed using optimization under constraints technique. According to an embodiment of the invention, the user is interacting with machine 26 by providing desired constraints. Examples of constraints include, but are not limited to, a desired level of purity, a desired level of accuracy, minimal rejection rate, and the like. The group of candidate pairs of threshold values is thereby limited to include those pairs of threshold values that satisfy the one or more constraints. In other words, pairs of threshold values that yield acceptable values of performance measures are identified as permitted pair values. Pairs of threshold values that yield unacceptable values of performance measures are identified as non-permitted pair values. According to an embodiment of the invention, the performance constraints are used for generating the performance metrics and only permitted pair values are used while applying the classification rules to the test data, thereby avoiding exhaustive, time-consuming computations.

The invention is not limited by the type and kind of optimization techniques which can be used. Optimization techniques may include, but are not limited to, greedy iterative algorithms, Lagrange multipliers, linear or quadratic programming, branch and bound, and evolutionary or stochastic constrained optimization.

According to an embodiment of the invention, a greedy iterative algorithm is used with one or more performance measures being held at a desired level (optimization under constraint problem). For example, with respect to the illustration of FIG. 3, at each iteration of the greedy iterative algorithm search, different confidence threshold value are applied, the rejection rates listed in column 78 will increase, as will the rejection of minority defects 80, while purity is maintained at a level that is no less than the minimum acceptable purity value. In addition to or instead of purity, other constraints on rejection threshold may be used, such as minimal threshold for UNK or CND defects regardless of purity values. The greedy iterative algorithm search may be defined to find a set of confidence threshold values such that: for each of the majority classes, the purity is no less than a predefined minimum purity value; for each of the majority classes, the minimal rejection thresholds for UNK and CND defects are no lower than specified values; the overall rate of rejection of the minority defects (referred to as the minority extraction rate), as a weighted average over rates 80, is no less than a certain minimum target rate; or the average rate of rejection of the majority defects, as a weighted average of the values in rows 60 of column 78, is the lowest rate that can be found that still satisfies the above conditions on purity and minority extraction. In this example, the target performance measure is the purity, while the minority extraction rate defines an operating criterion for machine 26. The invention is not limited by the type of performance measures used, the type of constraints and their desired levels, or the implementation of optimization under constraints approach. The invention may be applied to automatically find sets of threshold values that satisfy other sets of performance measures and operating criteria, depending on the needs and objectives of the classification.

According to an embodiment of the invention, a human operator (user) is providing one or more desired performance levels. For example, the user is interacting with the machine through an input/output module (e.g. GUI, display and keyboard) and is able to input one or more desired performance values. Based on this input the preferred confidence threshold values for each automatic class are selected. Such desired performance values may include one or more of minimal purity, minimal accuracy, maximal rejection rate of majority items, minimal item of interest rate, minimal minority extraction, maximal false alarm rate, and minimal confidence threshold value.

According to an embodiment of the invention, the preferred confidence threshold values are selected automatically. For example, the preferred confidence threshold values are those corresponding to minimal rejection rate at a given purity or accuracy level.

According to an embodiment of the invention, the selection of the preferred confidence threshold values is performed in a manual or semi-manual manner. The user is provided with a variety of candidate confidence threshold values for each automatic class and is enabled to select the preferred confidence threshold values for each automatic class in a manual process. For example, in the example described with respect to FIG. 3, the user is provided with a plurality of pairs of candidate CND and UNK confidence threshold values for each automatic class that satisfies a certain minimal purity or accuracy; each such pair represents a different CND and/or UNK confidence threshold values. The data may be presented to the user in the form of a graph. The graph may be a two-dimensional graph construed by defining a grid of a first performance measure on an x axis and finding a global optimum condition of a second performance measure for a y axis for each point of the first performance measure. The graph may be a three-dimensional graph construed by defining a grid of a first performance measure on x axis and finding a global optimum condition of a second and third performance measures for y axis and z axis for each point of the first performance measure. In any case, each point on the graph (“working point”) represents an acceptable set of threshold values (candidate confidence threshold values for each automatic class) under certain performance measure levels. Put differently, each working point provides a different trade-off between the performance measures. The user may be provided with additional visualization and information relating the candidate working points. For example, the user may be provided with visualization of the one or more desired performance measure level (constraints) under which the working points were generated (such as the value of the respective performance measure/s). The user may be provided with performance level values corresponding to the working points. The user may be provided with threshold values for a specific automatic class and/or threshold values corresponding to a certain performance measure. The user may be provided with statistical boundaries for each working point representing possible errors or tolerances with respect to performance measures (e.g., visualized as error bars), and more. By this visualization, the user is enable in-depth investigation of specific aspects of the selection.

As shown at Block 460, a preferred set of confidence threshold values is selected. The preferred set of confidence threshold values may be selected by the user. User selection may be provided through the input/output module by moving a cursor or pointer on the graph and selecting a desired working point. The invention is not limited by the type of data structure and visualization technique used for presenting the data to the user. The invention is not limited by the type of GUI and input/output modules that are used for interacting with the machine. The preferred set of confidence threshold values may be selected in an automated manner.

Classification stage 420:

At Block 480, classification data is received from the inspection machine (or from another machine). Alternatively, inspection results are received from the inspection machine and classification data including items (e.g. defects) is generated by machine 26, depending on the specific system configuration.

At Block 490, the classification rules are applied by machine 26 to the classification data using the preferred set of confidence threshold values which were selected for the automatic classes, and the items (defects) are thereby classified.

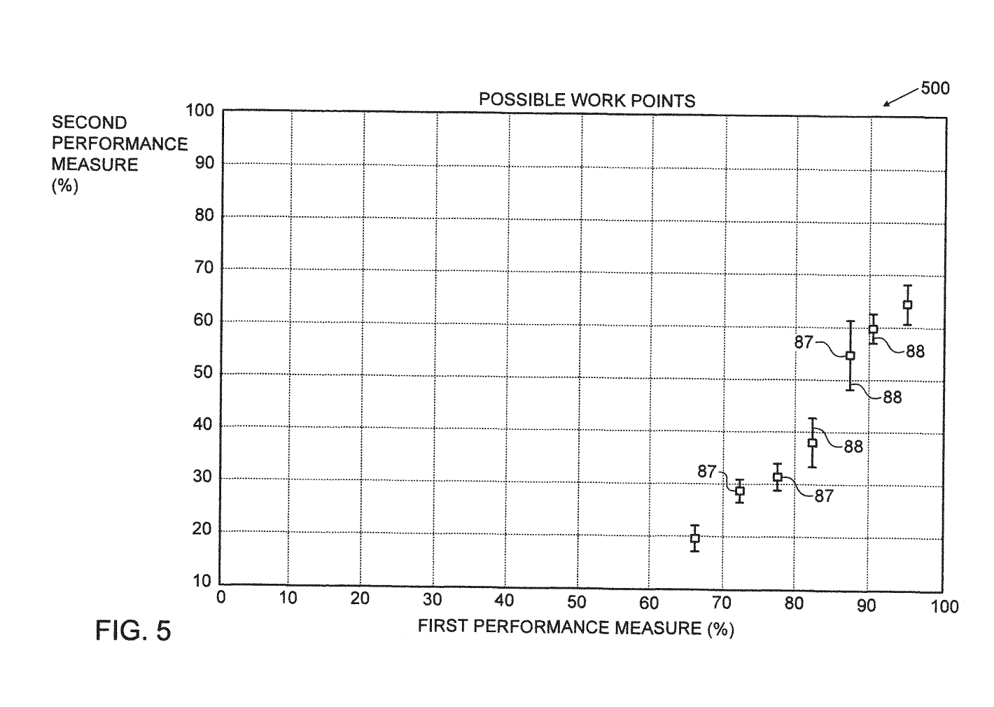

FIG. 5 is a schematic of a graph 500 presented to a user in accordance with an embodiment of the invention. The graph 500 may be presented to the user by the machine 26 or the processor 28 of the machine 26 of FIG. 1. The abscissa of the graph in this non-limiting example is a first performance measure (e.g., the DOI capture rate), while the ordinate is a second performance measure (e.g., false alarm rate). The performance measures are expressed as percentages and computed in the manner defined above. Each point 87 on the graph represents a candidate working point of machine 26, corresponding to a set of classifier confidence threshold values, as explained above. In the example shown in FIG. 5, each working point is assigned with error bars 88, indicating statistical boundaries for each working point representing possible errors or tolerances with respect to performance measures (also referred to as ‘stability’). The working points 87 may be shown with no error bars. The working points may be shown in a discrete manner (as in FIG. 5) or as dots on a continuous line.

The graph 500 can be generated by defining a grid of desired values in the first performance measure and optimizing the other performance measure given the first measure value. Alternatively, an iterative algorithm which considers all performance measures at once can be applied, modifying, in each iteration, one or more class confidence thresholds so that the ratio between the changes in each of the competing performance measures is optimal. This can be achieved by greedy iterative algorithm or any other constraint optimization technique such as Lagrange multipliers, linear or quadratic programming, branch and bound, or evolutionary or stochastic constrained optimization. For each of these techniques, consecutive optimization steps may be accumulated to create the graph of working points. The stability error bars can be estimated by combining multiple runs statistics on data partitions (e.g., by boosting or cross-validation methods).

In the context of inspection and classification of defects performed in manufacturing of semiconductor devices, the following performance measures may be used: a purity measure, representing items which were classified as belonging to one of the automatic classes and have the same training class and test class; an accuracy measure, representing all items which are classified correctly; rejection rate of majority items, representing the number of items that the classification system should have classified as belonging to one of the automatic classes but is unable to classify with confidence; item of interest rate, representing the number of items that are identified correctly as belonging to specific automatic class; minority extraction, representing the number of items that are identified correctly as not belonging to automatic classes; false alarm rate, representing a number of items that should have been rejected and are classified as belonging to one of the automatic classes, out of the total number of rejected items. The invention is not limited by the type of performance measures that are used and can be implemented with other performance measures with the required modifications without departing from its scope.

The disclosure was described with reference to UNK confidence level ('Unknown' confidence threshold, representing a confidence level for which, an item that is classified by a single-class classifier as belonging to an automatic class with confidence level below the ‘Unknown’ confidence threshold will be rejected) and CND confidence level ‘Cannot decide’ confidence threshold, representing a confidence level for which, an item that is classified by a multi-class classifier as belonging to an automatic class with confidence level below the ‘Cannot decide’ confidence threshold will be rejected). In the context of inspection and classification of defects performed in manufacturing of semiconductor devices, other confidence levels may be used. For example, an ‘Item of interest’ confidence threshold, representing a confidence level for which, an item that is classified by a multi-class and single-class classifiers as belonging to a specific automatic class with confidence level below the ‘Item of interest’ confidence threshold will be rejected. The invention is not limited by the type of confidence levels that are used and any confidence level that impact a definition of a class or a classification rule can be used without departing from the scope of the invention.

Embodiments of the invention will be described with respect to Automatic Defect Classification (ADC) techniques and systems which can be used in inspection and measurement of defects on substrates in the semiconductor industry. The invention is useful for many other applications at various industries, without departing from the scope of the invention.

Embodiments of the invention will be described with respect to performance measures relevant for inspection and defect detection in the semiconductor industry, such as accuracy, purity, rejection rate, ‘Cannot Decide’ (CND) confidence level and ‘Unknown’ (UNK) confidence level. The invention is not limited for the described applications and can be used for other applications (e.g., optimization of different performance measures) without departing from the scope of the invention.

The embodiments of the invention will be described with respect to classification systems that can characterize unclassified defects as ‘unknown’ or ‘cannot decide.’ The invention is not limited to such classifiers and can be used with other types of classification systems which are characterized by competing performance measures, without departing from the scope of the invention.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

The invention was described with respect to certain system configuration alternatives. Regardless of the way the system is implemented, it would usually include one or more components that are capable, inter alia, of processing data. All such modules, units and systems which are capable of data processing may be implemented in hardware, software, or firmware, or any combination thereof. While in some implementations such processing capabilities may be implemented by dedicated software which is executed by general purpose processors, other implementations of the invention may require utilizing dedicated hardware or firmware, especially when volume and speed of processing of the data are of the essence. The system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention. A program of instructions may be implemented, which, when executed by one or more processors, results in the execution of method 400 or one of the aforementioned variations of method 400 even if the inclusion of such instructions has not been explicitly elaborated.

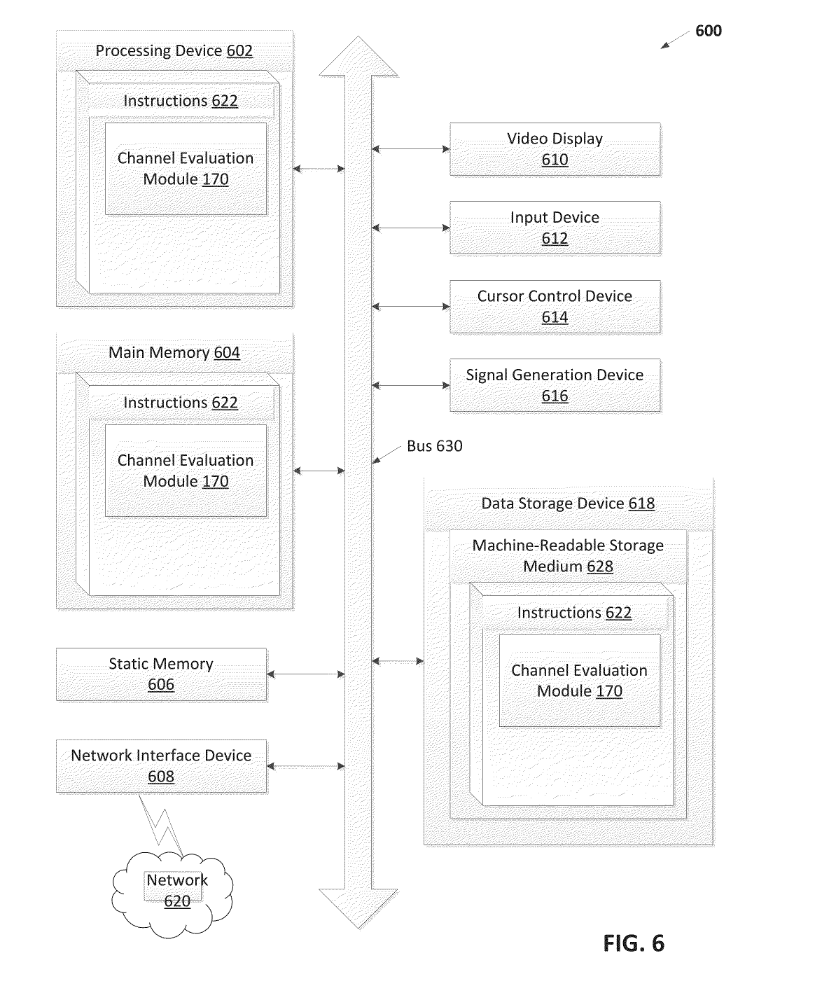

FIG. 6 illustrates a diagram of a machine in an example form of a computer system 600 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 614, which communicate with each other via a bus 630.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 622 for performing the operations and steps discussed herein.

The computer system 600 may further include a network interface device 604. The computer system 600 also may include a video display unit 610 (e.g., a liquid crystal display (LCD) or a cathode ray tube (CRT)), an input device 612 (e.g., a keyboard, and alphanumeric keyboard, a motion sensing input device), a cursor control device 614 (e.g., a mouse), and a signal generation device 616 (e.g., a speaker).

The data storage device 614 may include a computer-readable storage medium 624 on which is stored one or more sets of instructions 622 (e.g., software) embodying any one or more of the methodologies or functions described herein. The instructions 622 may also reside, completely or at least partially, within the main memory 604 and/or within the processor 602 during execution thereof by the computer system 600, the main memory 604 and the processor 602 also constituting computer-readable storage media. The instructions 622 may further be transmitted or received over a network 620 via the network interface device 608.

While the computer-readable storage medium 628 (machine-readable storage medium) is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “causing”, “providing”, “identifying”, “filtering”, “calculating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus may be constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A method comprising:
receiving, by a processing device, training data including items, each associated with a training class label;
obtaining test data including an association of each item with an automatic class label and corresponding values of a first confidence level and a second confidence level;
per each automatic class, generating two or more performance metrics based on the training data and the test data;
selecting, for each automatic class, a preferred pair of values of the first confidence threshold and the second confidence threshold for which, by rejecting all items below the first and second confidence thresholds, with respect to all of the automatic classes, a global optimum condition of the performance metrics is met.

2. The method according to claim 1, wherein the global optimum condition is met under one or more performance constraints applied to the performance metrics.

3. The method according to claim 1, wherein the selecting of the preferred pair of values of the first confidence threshold and the second confidence threshold comprises:
for each automatic class, generating a group of candidate pairs of values; and
selecting from among the candidate pairs of values, a preferred pair of values for which, with respect to all of the automatic classes, the global optimum condition of the performance metrics is met.

4. The method according to claim 3, wherein the preferred pair of values is selected based on input received from a user regarding one or more desired performance levels.

5. The method according to claim 4, further comprising:
plotting a graph representing a set of candidate pairs of values and allowing the user to use the graph for selecting the preferred pair of values from the set of candidate pairs of values.

6. The method according to claim 5, wherein the graph is constructed by defining a grid of a first performance metric on an x axis and finding a global optimum condition of a second performance metric for a y axis for each point of the first performance metric.

7. The method according to claim 3, wherein one or more performance constraints are applied to the group of candidate pairs of values to generate a group of permitted pair values, and wherein the preferred pair of values is selected from the group of permitted pair of values.

8. The method according to claim 1, wherein the items are suspected defects inspected on a semiconductor substrate.

9. The method according to claim 1, wherein obtaining test data is carried out by applying the classification rules to at least a portion of the training data, with the first confidence threshold and the second confidence threshold set to given values.

10. The method according to claim 1 wherein the generating two or more performance metrics is performed by comparing the training class label with the automatic class labels.

11. The method according to claim 1, wherein generating two or more performance metrics is carried out by applying the classification rules to the training data multiple times, with the first confidence threshold and/or the second confidence threshold set to a different value each time.

12. The method according to claim 1, wherein the performance metrics relate to one or more performance measures from one or more of:
a purity measure representing items which were classified as belonging to one of the automatic classes and having the same training class and test class;
an accuracy measure representing all items which are classified correctly;
a rejection rate of majority items representing the number of items that the classification system should have classified as belonging to one of the automatic classes but is unable to classify with confidence;
an item of interest rate representing the number of items that are identified correctly as belonging to specific automatic class;
a minority extraction representing the number of items that are identified correctly as not belonging to automatic classes; and
a false alarm rate representing a number of items that should have been rejected and are classified as belonging to one of the automatic classes, out of the total number of rejected items.

13. The method according to claim 2, wherein the performance constraint is selected from at least one of:
a minimal purity;
a minimal accuracy;
a maximal rejection rate of majority items;
a minimal item of interest rate;
a minimal minority extraction;
a maximal false alarm rate; and
a minimal confidence threshold value.

14. The method according to claim 1, wherein the first confidence threshold and second confidence threshold are selected from at least one of:
an ‘Unknown’ confidence threshold representing a confidence level for which, an item that is classified by a single-class classifier as belonging to an automatic class with confidence level below the ‘Unknown’ confidence threshold will be rejected;
a ‘Cannot decide’ confidence threshold representing a confidence level for which, an item that is classified by a multi-class classifier as belonging to an automatic class with confidence level below the ‘Cannot decide’ confidence threshold will be rejected; and
an ‘Item of interest’ confidence threshold representing a confidence level for which, an item that is classified by a multi-class and single-class classifiers as belonging to a specific automatic class with confidence level below the ‘Item of interest’ confidence threshold will be rejected.

15. An apparatus for tuning a classification system, the apparatus comprising:
a memory ;
a processor operatively coupled with the memory to:
receive training data including items, each associated with a training class label;
obtain test data including association of each item with an automatic class label and corresponding values of a first confidence level and a second confidence level;
wherein the processor is further configured for:
per automatic class, generate two or more performance metrics based on the training data and the test data; and
select, for each automatic class, a preferred pair of values of the first confidence threshold and the second confidence threshold for which, by rejecting all items bellow the first and second thresholds, with respect to all of the automatic classes, a global optimum condition of the performance metrics is met.

16. The apparatus according to claim 14, wherein the processor is further to receive one or more performance constraints and achieve the global optimum condition under the one or more performance constraints applied to the performance metrics.

17. The apparatus according to claim 14, wherein the processor is further to select a preferred pair of values of the first confidence threshold and the second confidence threshold by:
for each automatic class, generate a group of candidate pairs of values; and
select from among the candidate pairs of values, a preferred pair of values for which, with respect to all of the automatic classes, a global optimum condition of the performance metrics is met.

18. The apparatus according to claim 16, wherein the processor is further to receive input from a user regarding one or more of desired performance levels, and for selecting the preferred pair of values based on said input received from a user.

19. The apparatus according to claim 17, wherein the processor is further to:
provide an output to the user a graph representing a set of candidate pairs of values; and
enable the user to use the graph for inputting said one or more of desired performance levels.

20. The apparatus according to claim 18, wherein the graph is constructed by defining a grid of a first performance metric on x axis and finding a global optimum condition of a second performance metric for y axis for each point of the first performance metric.

21. A non-transitory computer-readable medium including instructions, which when executed by a processor, cause the processor to:
receive training data including items, each associated with a training class label;
obtain test data including association of each item with an automatic class label and corresponding values of a first confidence level and a second confidence level;
per automatic class, generate two or more performance metrics based on the training data and the test data; and
select for each automatic class a preferred pair of values of the first confidence threshold and the second confidence threshold for which, by rejecting all items bellow the first and second thresholds, with respect to all of the automatic classes, a global optimum condition of the performance metrics is met.

22. The non-transitory computer-readable medium according to claim 20, wherein the global optimum condition is achieved under one or more performance constraints applied to the performance metrics.

23. The non-transitory computer-readable medium according to claim 20, wherein the processor is further to select a preferred pair of values of the first confidence threshold and the second confidence threshold by:
for each automatic class, generate a group of candidate pairs of values; and
select from among the candidate pairs of values, a preferred pair of values for which, with respect to all of the automatic classes, a global optimum condition of the performance metrics is met.

24. The non-transitory computer-readable medium according to claim 22, wherein the processor is further to receive input from a user regarding one or more of desired performance levels, and to select the preferred pair of values based on said input received from a user.

25. The non-transitory computer-readable medium according to claim 22, wherein the processor is further to:
provide an output the use a graph representing a set of candidate pairs of values, and enable the user to use the graph for inputting said one or more of desired performance levels.

26. The non-transitory computer-readable medium according to claim 18, wherein said graph is constructed by defining a grid of a first performance metric on x axis and finding a global optimum condition of a second performance metric for y axis for each point of the first performance metric.

27. A method for classifying items, the method comprising:
during a setup stage, applying the method of any of claims 1-13;
during a classification stage, receiving classification data including items and classifying the items based on the automatic classes and using the preferred pair of values of the first confidence threshold and the second confidence threshold.

28. A system for classifying items, the system comprising classification module capable of receiving classification data items and classifying the items based on automatic classes, wherein the classification module comprising an apparatus for tuning a classification system according to claims 14 to 19.
